(19) United States
(12) Patent Application Publication
(10) Pub. No.: US 2017/0129153 A1
(43) Pub. Date: May 11, 2017

(54) An Apparatus and a Method for Constructing a Construction Element or a Building

(71) Applicant: Fimatec Finnish Intelligent Module Apartments Oy, Imatra, E-Suomi (FI)

(72) Inventor: Arto Koivuharju, Imatra (FI)

(21) Appl. No.: 15/322,355

(22) PCT Filed: Mar. 27, 2015
(86) PCT No.: PCT/FI2015/050214

§ 371 Date: Dec. 27, 2016

(30) Foreign Application Priority Data
Jun. 27, 2014 (FI) 20145622

(51) Int. Cl. B29C 47/02; B29C 47/06; E04G 21/04; E04B 1/16; E04B 1/35; E04G 11/34; B28B 3/26; B29C 67/00

(52) U.S. Cl. CPC B29C 47/025; B28B 3/2636; B28B 3/2645; B29C 47/065; B29C 67/0081; E04B 1/16; E04B 1/3505; E04G 11/34; E04G 21/04; B33Y 30/00

(57) ABSTRACT

The invention relates to an apparatus for constructing comprising at least feeding means for providing construction material in layers. The apparatus comprises at least first feeding means for hardening material, second feeding means for insulating material wherein said feeding means are configured to operate substantially concurrently so that a construction layer comprises materials from each feeding means. The apparatus may also provide reinforcement substantially concurrently with the other materials.

### TECHNICAL FIELD

The present solution generally relates to construction technology. In particular the present solution relates to an apparatus and a method for constructing a construction element or a building.

### BACKGROUND

Buildings, such as houses, are typically built by using building materials (bricks, timber, rock) or by using prefabricated wall elements. In both cases, the building and the prefabrication is manual work, where hardly no automation is used. Because of that, the house building is laborious and time consuming. Even though actual building process can be accelerated by using the prefabricated elements, the prefabrication of elements still needs time.

There is, therefore, a need for a solution by means of which time used for building e.g. house, can be shortened.

### SUMMARY

Now there has been invented an improved method and an apparatus implementing the method, by which the above need is fulfilled. Various aspects of the invention include a method and an apparatus, which are characterized by what is stated in the independent claims. Various embodiments of the invention are disclosed in the dependent claims.

According to a first aspect, there is provided an apparatus for constructing, said apparatus comprising at least feeding means for providing construction material in layers. The apparatus comprises a comprises at least first feeding means for first material, second feeding means for second material wherein said feeding means are configured to operate substantially concurrently so that a construction layer comprises materials from each feeding means.

According to an embodiment, the apparatus further comprises third feeding means for a third material.

According to an embodiment, the third feeding means being configured to operate substantially concurrently with the first and second feeding means.

According to an embodiment, the first material is a hardening material.

According to an embodiment, the second material is an insulation material.

According to an embodiment, the third material is reinforcement.

According to an embodiment, the hardening material is one of the following: concrete, wood cellulose.

According to an embodiment, the reinforcement is one of the following material: a steel wire, a fiberglass cord, a carbon fiber, a reinforced plastic.

According to an embodiment, during the construction the third feeding means are followed by the first and the second feeding means.

According to an embodiment, the first feeding means comprises at least two nozzles for providing the first material on the opposite sides of the construction layer.

According to an embodiment, the second feeding means are configured to feed the second material between the first material layers on opposite sides of the construction layer.

According to an embodiment, the third feeding means comprises at least two nozzles for providing the third material, which at least two nozzles are located in front of the nozzles of the first feeding means in operation direction.

According to an embodiment, the apparatus comprises coating means configured to perform coating of the first material on at least one side of the construction.

According to an embodiment, wherein the coating is one of the following: solar cell coating, smart film, touch sensitive film, paintwork, grout, plaster, carrier rib, laminate, wirings.

According to an embodiment, the coating means is configured to provide three-dimensionally shaped coating.

According to an embodiment, the coating means is configured to operate substantially concurrently with the first, the second and the third feeding means.

According to an embodiment, the apparatus further comprises twining means configured to bond the reinforcement to a reinforcement of the previous construction layer.

According to an embodiment, the apparatus further comprising twining means configured to twine a reinforcement wire to a reinforcement wire of the previous construction layer.

According to an embodiment, the apparatus is configured to construct a building or a wall element.

According to a second aspect, there is provided a method for constructing a building or an element, said method comprising feeding a hardening material and an insulation material and a reinforcement in layers, wherein the hardening material and the insulation material and the reinforcement are fed substantially concurrently for a construction layer.

### DESCRIPTION OF THE DRAWINGS

In the following, various embodiments of the invention will be described in more detail with reference to the appended drawings, in which

FIG. 1 shows an apparatus according to an embodiment for constructing a building;

FIG. 2 shows an apparatus according to an embodiment;

FIG. 3 shows an apparatus of FIG. 2 from another perspective;

FIG. 4 shows an example of a working direction of an apparatus when constructing an element;

FIG. 5 shows an example of a working direction of an apparatus when constructing a building;

FIG. 6 shows twining according to an embodiment;

FIG. 7 shows an example of a coating element;

FIG. 8a shows an embodiment of an apparatus; and

FIG. 8b shows an embodiment of a third coating component of the apparatus.

### DESCRIPTION OF EXAMPLE EMBODIMENTS

In the following, several embodiments of the invention will be described in the context of building houses. It is to be noted, however, that the invention is not limited to house building. In fact, the different embodiments have applications in any building environment where constructing is needed. In the following materials such as concrete, insulation material and reinforcement are given as examples. However, it is appreciated that instead of these materials other materials can be used. For example, instead of concrete, any hardening material in a liquid form can be used, for example plastic or mixture of stone materials or wood cellulose or wood-plastic composite etc. Also, the insulation material can be polyurethane, however, other materials can be used instead. The reinforcement can be reinforcement bar, such as a steel bar, a reinforcement wire, a reinforcing composite, a fiberglass cord, a carbon fiber, a plastic composite (e.g. polypropylene composite). Also, when reinforcement is not used, the hardening material can be a combination of concrete and reinforcement.

The embodiments, according to an example, relate to a concrete printing apparatus, which is used in automatic on-the-spot construction. The apparatus extrudes, hardens, prints and connects materials which then create a house or house element. The apparatus is configured to build base structures but also complete buildings of combination of concrete and insulation material and alternatively also with reinforcement. In addition, the apparatus is able to laminate and spread different materials (e.g. solar cell coating) with coating means. The apparatus according to embodiments is configured to feed reinforcement within the wall during the construction. Due to that the wall under construction will become ready for the living purposes.

In addition, the constructed wall meets the requirements of construction code also in countries having varying weather conditions. The embodiments of the invention are disclosed in more detailed manner next.

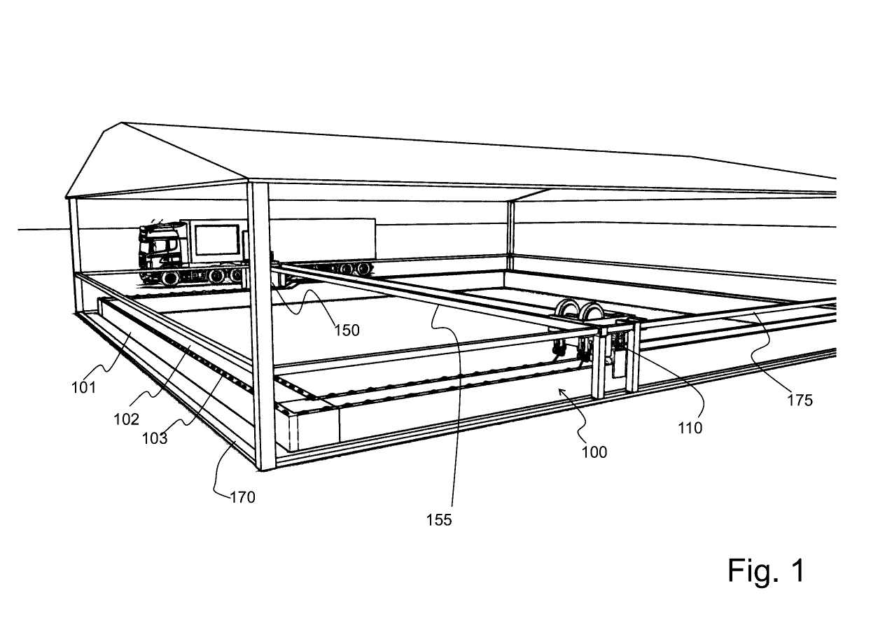

FIG. 1 illustrates an apparatus 110 for constructing a house or a construction element according to an embodiment. The element may be a wall element for a house or for any other building. In some cases, the element may be a floor element or a roof element. In this embodiment, the apparatus is configured to construct a house.

The apparatus 110 shown in FIG. 1 constructs a house frame 100 of layers of materials. In this example, the house is constructed from ground towards the sky, however, the embodiments may be utilized when constructing a wall element sideways. In this embodiment, the apparatus is connected to a material container 150 via material passing tubes 155. The apparatus 110 is configured to be guided by guiding trails 170 or guiding frame 175 or by wheels or any combination of the previous.

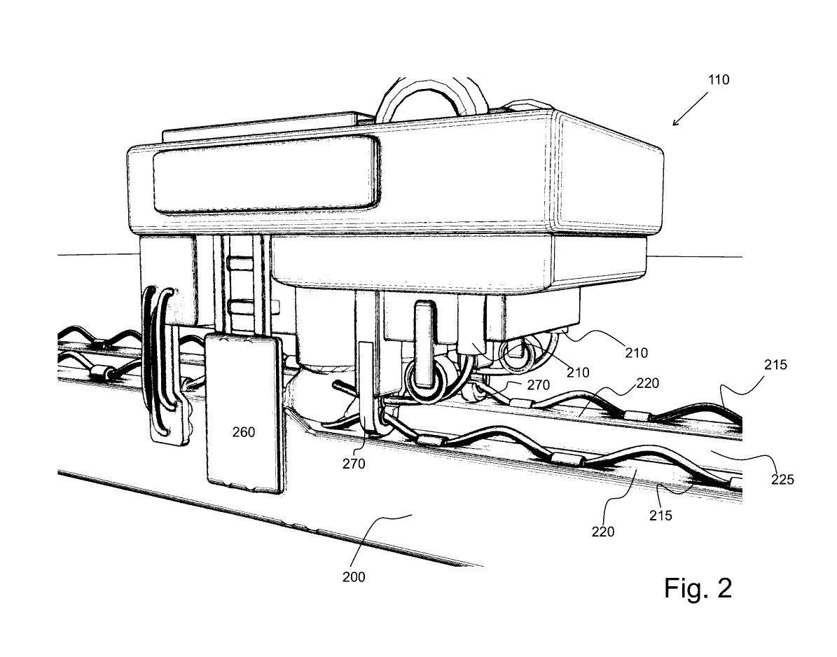

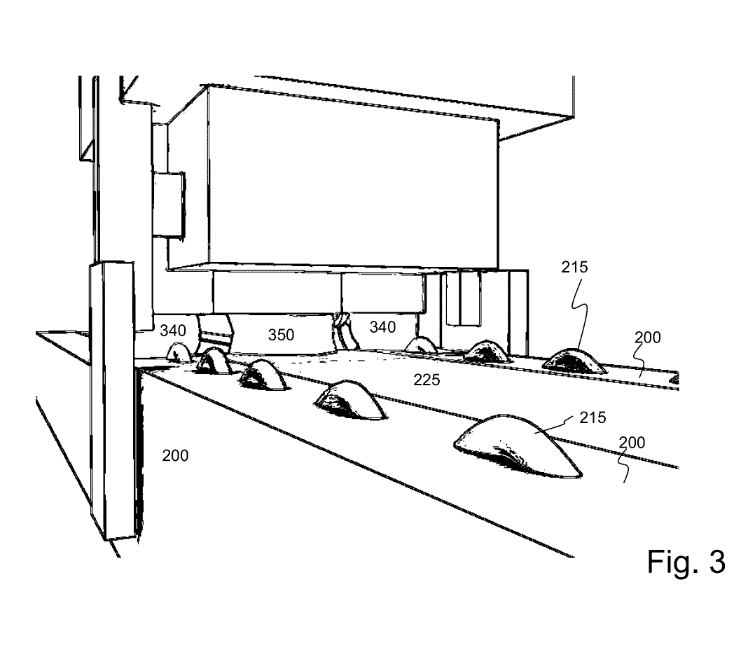

As is shown in FIG. 1 and will be disclosed in more detailed manner with reference to FIGS. 2 and 3, the building or an element is constructed of material layers, where, according to an embodiment, each layer comprises hardening material (e.g. concrete, wood cellulose) 101, insulation material (e.g. polyurethane) 102 and reinforcement (e.g. steel, fiberglass cord, carbon fiber, plastic composite) 103. The hardening material (such as concrete or wood cellulose) 101 with reinforcement 103 is located in opposite sides of the wall/wall element, and the insulation material 102 is located between the opposite sides of the wall element.

In FIG. 1, a first layer (i.e. the basis) for the house has been constructed by applying a layer of concrete. This means that the nozzles for the reinforcement and insulation of the apparatus have been closed temporally. The first layer of concrete is provided with a reinforcement loop into which the reinforcement of the following layer will be fixed. After the first layer of concrete, the apparatus 100 begins to feed the reinforcement layer followed by the concrete layer and the insulation layer. Instead of concrete, also wood cellulose may be used for layers other than the first layer which usually is the basis.

The material layers can deviate from the previous example. According to an embodiment, only concrete/cellulose layer with reinforcement may be enough. According to an embodiment, the insulation layer can be composed on more than one insulation materials. According to an embodiment, the reinforcement is not needed, if the hardening material is composed of the hardening material and the reinforcing material. In that case each material layer comprises the hardening material and the insulation. Yet further, according to an embodiment, the order and/or amount of the materials at each layer may be different. For example, there may be additional layer of concrete within the insulation material, or there may be additional wirings.

As mentioned, the apparatus is discussed in more detailed manner with reference to FIGS. 2 and 3. The apparatus 110 comprises nozzles for providing layers of construction materials for the wall element/wall. The apparatus comprises groups of nozzles, the amount of which may correspond to the different materials being used for the wall element or the structure of the wall element. Each group of nozzles comprises at least one nozzle.

According to an embodiment, there are three groups of nozzles, one for concrete or wood cellulose (FIG. 3: 340), one for insulation material (FIG. 3: 350) and one for reinforcement (FIG. 2: 210). The groups of nozzles are arranged in the apparatus in such a manner that they can operate concurrently. This means that when constructing the layers other than the base layer and the layer at room height, the apparatus is at first configured to feed the reinforcement, e.g. steel wire 215 or any other reinforcing material.

The reinforcement feeding is followed with group of nozzles extruding a layer of concrete 220 or wood cellulose on opposite sides of the wall element, and another group of nozzles extruding a layer of insulation 225 between the opposite concrete (or wood cellulose) layers 220. This means that for such embodiment, the nozzles 210, 340, 350 are arranged to the apparatus so that at first in the moving direction, there are nozzles 210 for the reinforcement, which are then followed by the nozzles 340, 350 for concrete (or wood cellulose) and insulation material.

It is appreciated that together with or instead of the reinforcement feed, the apparatus may provide heating cables within the construction. These can be powered by any known system, and therefore also by solar energy that can be obtained via solar cell coating of the construction.

According to an embodiment, the apparatus further comprises coating means 260. There may be coating means 260 on the both sides of the apparatus so that they are able to perform coating for the both internal and external sides of the wall element. The coating means may also be located only on one side of the apparatus.

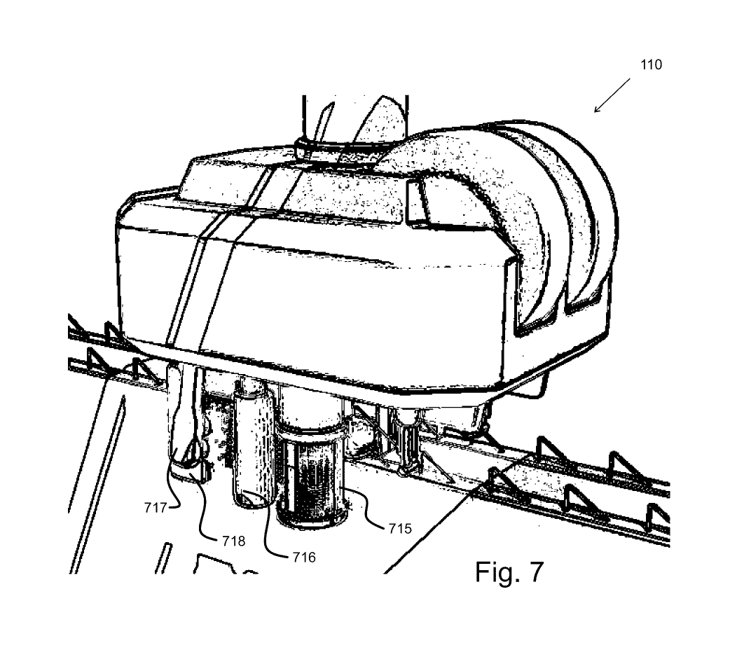

According to an embodiment, the coating means are configured to produce a final surface to the wall at the same time when the wall is being constructed. The coating means may comprise one or more different coating components. There can be a coating component for paintwork, for plaster, for grout, for carrier rib, for laminate, for direct write technology, for wirings, for smart film, for touch sensitive coating. The coating means for the external side of the wall can also provide the solar cell coating for the wall from a corresponding coating element. According to an embodiment, shown in FIG. 7, there are four coating components 715, 716, 717, 718. A first coating component 715 is configured to provide the carrier rib from a roller. A second coating component 716 is configured to tighten the rib from the first coating component 715 to be even. A third coating component 717 is a spraying component being configured to provide e.g. a plaster. A fourth coating component 718 is configured to perform the grouting and finalize the surface. The third coating component 717, i.e. the spraying component, is configured to plaster the surface of the wall horizontally. In addition, the third coating component 717 may be configured to create three-dimensional surface, e.g. different shapes extending from the wall horizontally. This means that the third coating component 717 may be configured to create shapes of pillars on the wall by spraying the hardening material horizontally. Also the third coating component is configured to operate substantially concurrently with the other feeding means, so that the wall being constructed comprises not only the vertically layered materials but also horizontally layered materials being fed at the same time.

It is appreciated that FIG. 7 is given for illustration purposes, and the amount, the order and the functions of the coating components may vary. For the carrier rib, the apparatus may further comprise a stapler for stapling the carrier rib strip to the carrier rib strip of the lower layer. By the stapling, the carrier rib strips will turn into a wall-high and wall-wide carrier rib. Instead of stapling, other fixing methods may be used, e.g. gluing.

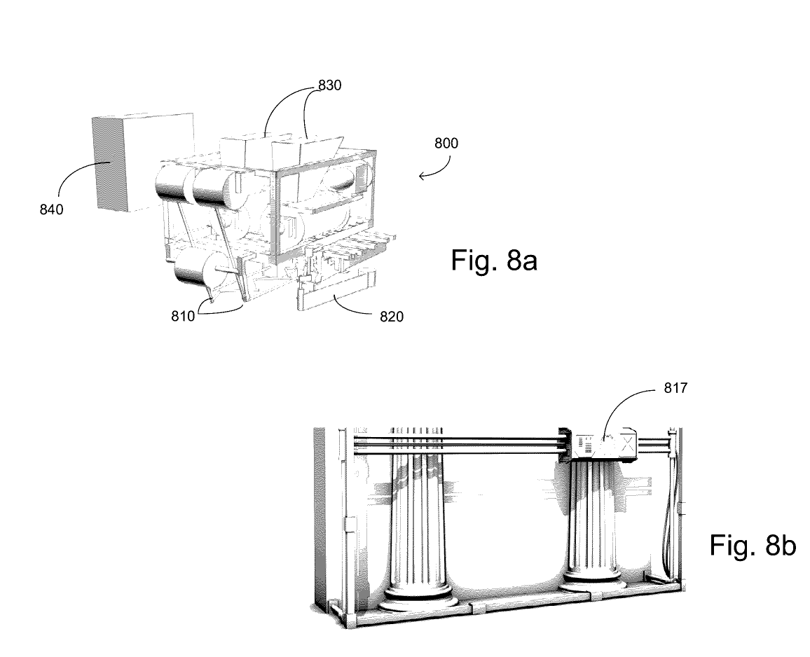

FIG. 8a illustrates an embodiment of an apparatus 800. The apparatus 800 comprises in this simplified figure shows a control unit 840, a reinforcement feed 810, means 820 for providing a carrier rib and means 830 for feeding hardening material. FIG. 8b further shows an example of a third coating component 817 (element 717 in FIG. 7) being configured to provide three-dimensional shapes, i.e. pillars in FIG. 8b. It is appreciated that for understanding purposes the third coating component 817 is shown separately of the apparatus 800 of FIG. 8a. However, as shown in FIG. 7, the third coating component is part of the apparatus 800.

According to an embodiment, the apparatus also comprises twining means 270, such as two twiners (FIG. 2). According to an embodiment, there is a twiner between a reinforcement nozzle and a concrete (or wood cellulose) nozzle. The purpose of the twining means 270 is to twine a reinforcement wire to the reinforcement wire of the previous layer before the concrete (or wood cellulose) is extruded. By this, the reinforcement for both sides of the wall becomes stronger. FIG. 2 illustrates the twining means 270 in operation. Instead of twining, the twining means 270 may press or weld or staple the reinforcement wires together.

FIG. 3 shows the result of a wall layer after the apparatus has operated. It is realized that the layer has all the materials needed for the wall. It has exteriors made of concrete 200 or wood cellulose, it has insulation material 225 between the concrete/wood cellulose exteriors 200, and it has reinforcement 215 within the concrete/wood cellulose. It is to be noticed that the reinforcement wire is partly over the extrusion level of the concrete. This is because when the next layer is constructed, the reinforcement wiring of the next layer is easily twined to the reinforcement layer of the present layer.

It is to be noticed that in some embodiments, the twining can be made horizontally. This means that the reinforcement would extend between different sides of the wall/wall element over the insulation material. Such twining would generate even more strong construction. The idea of such twinging is given with FIG. 6 showing a horizontal twining in very simplified manner. It is further appreciated that the twining can be made both horizontally and vertically.

When a fiberglass cord is used as the reinforcement, the apparatus may feed the fiberglass cord directly within the hardening material. The fiberglass cord is composed of strands, which can be separated at the time the reinforcement made of fiberglass cord is fed within the wall. For the separation, the apparatus may further comprise a comb or other separating means. The separated fiberglass cord strands may be drifted to different places within the hardening material, whereby the fiberglass reinforcement will be strong. In addition, the fiberglass cord may also be twined as the reinforcement wire according to the embodiment shown in FIG. 6.

For even stronger construction, additional reinforcing can be provided e.g. by internal connector or anchoring pins that connect the adjacent concrete layers having the insulation material between together.

When an apartment building is being constructed, starter bars having a height of even 2.5 meters may be anchored to the footing, after which the concrete may be extruded. The starter bars may be utilized also by the present embodiments. For example, the reinforcement may—in addition or instead of the twining described above—be bound to the starter bars. The binding can be done e.g. by using a crown stapler or some other stapling device. It is appreciated that when starter bars are anchored in the footing of the construction, the nozzles of the apparatus should be provided in such a manner that in operation the apparatus is able to bypass the starter bars. This means that the apparatus may not comprise any beams that might collide with the starter bars and the nozzles should be located on both sides of the wall so that the starter bar are passed.

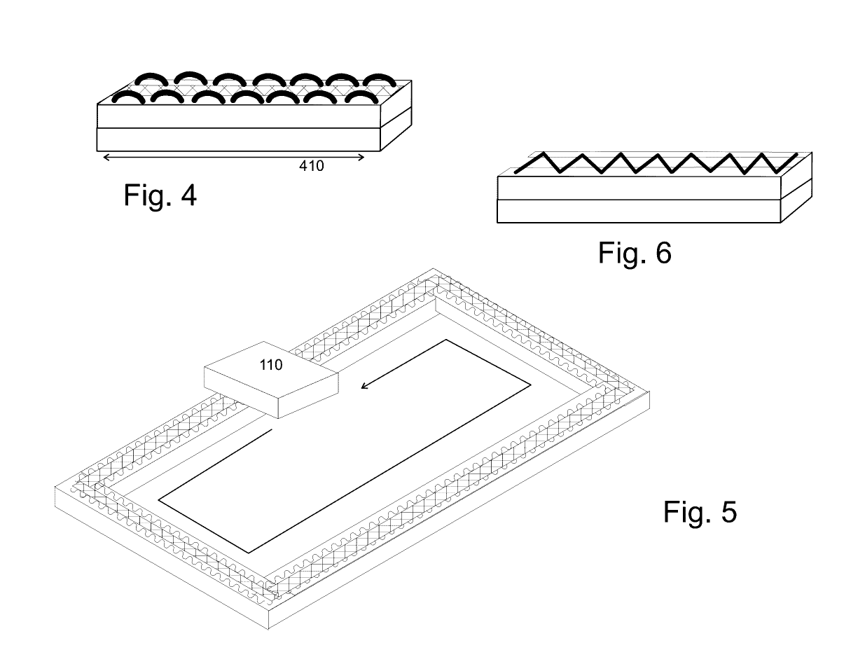

FIGS. 4 and 5 shows in simplified manner, the working directions of the apparatus. FIG. 4 shows construction of a wall element, where the apparatus is configured to operate in both directions (see the arrow 410). FIG. 5 shows a construction of a building, where the apparatus 110 is configured to move to one direction (pointed by the arrow). In addition, for complete building, the apparatus may also construct separating walls within the building. For that purpose (and also for the corners in the building), the apparatus has a joint, by means of which turning is made possible. The apparatus is also configured to construct pillars, and also vertical elements.

The embodiments also relate to a method, wherein hardening material, insulating material and reinforcement are fed for a layer. The feeding of the materials occurs substantially concurrently, so that—according to embodiment—the reinforcement feeding is followed by the feeding of hardening material and feeding of insulating material. Therefore, a construction layer after one round of apparatus's execution comprises all the needed materials for a wall or a wall element.

The apparatus may be controlled by a control software. Such a control software can be executed by a computer comprising memory and processing means. The memory stores computer code to implement the control of the construction apparatus. For example, the code may cause the apparatus to temporally shut down certain nozzle groups, the code may cause the apparatus to change a material feeding, the code may cause the apparatus to perform construction of different sizes, or different shapes. The apparatus may comprise a sensor that is configured to determine the width and height of each layer, and to control the material feeding based on the determination. The computer code may also receive user input to control the construction apparatus. The computer code may also control the construction apparatus based on commands determined by a client software. The client software may be provided for customer ordering a house. By means of such client software, the customer may select a complete house, or outline a house by means of different house modules. The software has functionalities for receiving user input for a sketch and for giving proposals on the sketch according e.g. a construction legislation. Such software are executed in a computer having a process and a memory. The software comprises computer instructions for carrying out various functions. The client software may communicate with a server software, which in turn may control the control software for the construction apparatus. The client software can be a customer software, while the server software may be house provider's software. The control software is for the apparatus.

The various embodiments may provide advantages. This improved technology provides a functional solution, which is both fast and economical. By means of the present embodiments, individualized and modifiable houses and house elements and construction elements are achieved. In addition, the constructions made with the present apparatus fulfil the requirements of the construction regulations, because the constructions have insulation material between the concrete, and is not only a cell structure.

It is obvious that the present invention is not limited solely to the above-presented embodiments, but it can be modified within the scope of the appended claims.

1. An apparatus for constructing comprising at least feeding means for providing construction material in layers, characterized in that, the apparatus comprises at least first feeding means (340) for a hardening material, second feeding means (350) for insulation material and third feeding means (210) for reinforcement, wherein said feeding means (340, 350) are configured to operate substantially concurrently so that a construction layer comprises materials from each feeding means (210, 340, 350).

2. The apparatus according to claim 1, wherein during the construction the third feeding means (210) are followed by the first and the second feeding means (340, 350).

3. The apparatus according to claim 1, wherein the hardening material is concrete or wood cellulose.

4. The apparatus according to any of the claims 1, wherein the reinforcement is one of the following material: steel wire, fiberglass cord, carbon fiber, plastic composite.

5. The apparatus according to any of the claims 1, wherein the first feeding means (340) comprises at least two nozzles for providing hardening material on the opposite sides of the construction.

6. The apparatus according to claim 5, wherein the second feeding means (350) are configured to feed insulation material between the hardening material layers on opposite sides of the construction.

7. The apparatus according to any of the claims 2, wherein the third feeding means (210) comprises at least two nozzles for providing the reinforcement, which at least two nozzles are located in front of the nozzles of the first feeding means (340) in operation direction.

8. The apparatus according to any of the claims 1, further comprising coating means (260) configured to perform coating of the hardening material on at least one side of the construction.

9. The apparatus according to claim 8, wherein the coating is at least one of the following: solar cell coating, smart film, touch sensitive film, paintwork, grout, plaster, carrier rib, laminate, wirings.

10. The apparatus according to claim 8, wherein the coating means (260) is configured to provide three-dimensionally shaped coating.

11. The apparatus according to any of the claims 8, wherein the coating means are configured to operate substantially concurrently with the first, the second and the third feeding means.

12. The apparatus according to any of the claims 1, further comprising twining means (270) configured to bond the reinforcement to a reinforcement of the previous construction layer.

13. The apparatus according to any of the claims 1, further comprising twining means (270) configured to twine a reinforcement wire to a reinforcement wire of the previous construction layer.

14. The apparatus according to any of the claims 1, wherein the apparatus is configured to construct a building or a wall element.

15. A method for constructing a building or an element, said method comprising feeding a hardening material and an insulation material and a reinforcement in layers, wherein the hardening material and the insulation material and the reinforcement are fed substantially concurrently for a construction layer.
